(19) United States
(12) Patent Application Publication
(10) Pub. No.: US 2011/0225296 A1
(43) Pub. Date: Sep. 15, 2011

(54) AUTONOMOUS MANAGEMENT METHOD FOR PROCESSING UNEXPECTING EVENTS USING INTERACTION BETWEEN NODES IN SENSOR NETWORKS

(75) Inventors: Choong Seon Hong, Gyeonggi-do (KR); Mamun-Or Rashid, Gyeonggi-do (KR); Eung Jun Cho, Gyeonggi-do (KR)

(73) Assignee: University Industry Cooperation Group of Kyung-Hee, Yongin-si, Gyeonggi-do (KR)

(21) Appl. No.: 13/129,377

(22) PCT Filed: Nov. 13, 2008
(86) PCT No.: PCT/KR2008/006704

§ 371 Date: May 13, 2011

(30) Foreign Application Priority Data
Nov. 13, 2008 (KR) 10-2008-0112921

(51) Int. Cl. G06F 15/173

(52) U.S. Cl. 709/224

(57) ABSTRACT

The present invention relates to a sensor network, and more particularly, to a device and method for managing sensor nodes, in which with respect to predictable events and unpredictable events detected by sensors, the predictable events can be managed as existing policies and the unpredictable events can be managed by receiving policies for the unpredictable events from peripheral sensor nodes or peripheral sensor networks, i.e., both predicted events and unpredicted events can be intelligently managed. According to the method device for managing events detected by sensor nodes according to the present invention the present invention, in the case where unpredictable events are detected, policies for the detected unpredictable events received automatically from peripheral sensor nodes or peripheral sensor networks, so that both predictable and unpredictable events can be managed. Each time unpredictable events are detected, new policies for the detected unpredictable events are automatically generated, so that a manager does not need to update the policies for the unpredictable events every time. In addition, since both predictable and unpredictable events can be managed, the event management method of the present invention can be widely used in a variety of application fields requiring stability and accuracy.

### TECHNICAL FIELD

The present invention relates to a sensor network, and more particularly, to a device and method for managing sensor nodes, in which with respect to predictable events and unpredictable events detected by sensors, the predictable events can be managed as existing policies and the unpredictable events can be managed by receiving policies for the unpredictable events from peripheral sensor nodes or peripheral sensor networks, i.e., both predicted events and unpredicted events can be intelligently managed.

### BACKGROUND ART

A sensor network is a network which consists of sensor nodes that are operated with low calculation ability and low-capacity battery power. The sensor network is composed of a sensor field where sensor nodes are distributed and a sink which interconnects the sensor field and an external network. Such sensor nodes consist of sensing components, data processing components and communication components.

The sensor network consisting of a large number of sensor nodes allows the sensor nodes to detect the surrounding environment in a position where the sensor nodes are deployed and to transmit the detected data to one or more destination nodes called sinks. Such a sensor network is now used in a variety of application areas, including healthcare applications, military monitoring, home automation, environment and habitat monitoring, factory management, disaster monitoring, and the like.

Furthermore, technologies related with sensors, MEMSs, low-power electronics and low-power RF designsare progressed rapidly. Recently, the application of the sensor network is extended from an application area which was used only with a small amount of data and low calculation ability, to an application area employing high-rate data and delay-sensitive traffic, i.e., a sensor network for multimedia streaming. Therefore, the sensor network are expected to be widely used in a system dealing with bulk data or a complex and sophisticated automatic control system requiring high calculation ability.

FIG. 1 is a schematic view illustrating a topology and a routing method of a conventional sensor network.

Referring to FIG. 1(a), there is shown a sensor network with a planar topology. Sensor nodes constituting the sensor network transmit data collected by each sensor node to a sink node (i.e., base station) at the same levels as each other. In the sensor network with a planar topology, a manager transmits a query to all the sensor nodes soas to obtain desired data from the sensor nodes. The sensor nodes which collect data corresponding to the query transmitted thereto from the manager transmit the sensed data to the sink node. The sensor network with a planar topology employs an on demand routing protocol that establishes a routing path on basis of data so as to grasp any event occurring in a specific region, i.e., a routing scheme that well reflects the characteristics of the sensor network.

Referring to FIG. 1(b), there is shown a sensor network with a hierarchical topology. Sensor nodes constituting the sensor network transmit data to the sink node in such a fashion that hierarchical stages are configured between header nodes based on header nodes. Respective sensor nodes forms a predetermined set, and arbitrary sensor nodes are selected as head nodes so that the header nodes transmit the data sensed by each sensor node to the sink node directly or through cooperation with other header nodes.

FIG. 2 is a block diagram illustrating the configuration of a policy-based management system used in a conventional sensor network.

Referring to FIG. 2, a policy-based management system used in a conventional sensor network includes a policy management unit 10, a policy storage unit 20, a policy decision unit 30 and a policy execution unit 40. A user generates a policy for an environmental change which can be detected by the sensor nodes through the policy management unit 10, and stores the generated policy in the policy storage unit 20. For example, in the case where the sensor network is used to sense the temperature of the surrounding environment, the sensor nodes detect a temperature change of a place where the sensor nodes are deployed. Meanwhile, in the case where the sensor network is used to sense shocks applied to buildings, the sensor nodes detect a shock change of a place where the sensor nodes are deployed. In application areas of the sensor network, an environmental change detected by the sensor nodes will be hereinafter referred to as an “event”. In the case where the sensor nodes sense the event, a policy for the event means a management scheme of the sensor nodes for the sensed event.

In the case where the event is detected by sensing units (not shown) of the sensor nodes, the policy decision unit 30 requests the policy storage unit 20 to search whether or not a policy for the detected event is stored in the policy storage unit 20. Then, the policy storage unit 20 inquires the detected event and the stored events, and searches a policy for the same event as the detected event. The policy decision unit 30 decides the policy searched by the policy storage unit 20, and sets a management function to be executed for the detected event depending on the decided policy. The policy execution unit 40 executes management of the detected event depending on the management function set by the policy decision unit 30.

### DISCLOSURE OF INVENTION

### Technical Problem

The Internet is one of the largest distributed systems which have been manufactured by the human. A wireless sensor network is a system consisting of a plurality of sensors distributed in a specific region, and can be extended to a true distributed system when a plurality of sensor networks is connected to one another through the Internet. The Internet was originally developed for a simple application such as transmission of e-mails or files in a specific field, but the Internet users and applications employing the Internet are currently increasing enormously. The wireless sensor network is presently used in only a specific area, but it is also expected to be grown as a vast distributed system such as the Internet in the future since a variety of applications employing the sensor network are developed.

As the sensor network is grown as a vast distributed system, various management/communication protocols applied to the sensor network are developed. The design of an automated management protocol for self-configuration, self-protection, self-assessment, etc., becomes an important issue owing to the characteristics that the sensor network is applied to a location making it difficult or dangerous for people to access, the characteristics that various applications employing the sensor network coexist, or the like.

In the case where all the events detected by the sensor nodes constituting the sensor network are predictable ones, it is possible to establish policies for all the predictable events and manage the detected events depending on the established policies. Like this, a scheme in which policies for predictable events are previously established and the detected events are managed depending on the established policies is preferred to as a “policy-based management protocol”. However, a location where the sensor network is installed is dynamically changed depending on an external environment, and prediction of all the events which can occur actually is nearly impossible.

The above-mentioned management system of the conventional sensor network entails a problem in that it predicts events which can occur in the sensor network through a manager and stores only policies for the predicted events in the policy storage unit, so that if unpredicted events occur, it is impossible to manage the unpredicted events which have occurred.

Accordingly, the present invention has been made to solve the above-mentioned problems associated with the prior art, and it is an object of the present invention to provide a method and device for managing events detected by sensor nodes, in which both predictable and unpredictable events can be managed.

Another object of the present invention is to provide a method and device for managing events detected by sensor nodes, in which if unpredictable events are detected, policies for the detected unpredictable events can be automatically updated by receiving policies for the unpredictable events from peripheral sensor nodes or peripheral sensor networks.

### Technical Solution

To accomplish the above objects, according to one exemplary embodiment of the present invention, there is provided a method for managing an event detected by a sensor node in a sensor network consisting of sensor nodes, the method including the steps of: (a) detecting an event occurring in a location where the sensor node is installed; (b) searching whether or not the detected event is registered in the sensor node and a management policy for the detected event exists in the sensor node; (c) transmitting, if the policy for the detected event does not exist in the sensor node as a search result, a query message including query information on the policy for the detected event to peripheral sensor nodes or peripheral sensor networks (d) generating a new policy for the detected event based on a response message including information on the policy for the detected event, the response message being received from the peripheral sensor nodes or the peripheral sensor networks and responding to the query message and (e) managing the detected event depending on the generated new policy.

Preferably, the query message is broadcasted to the peripheral sensor nodes or the peripheral sensor networks of the sensing node which has detected the event, and includes the query information such as a query identifier, an event type, a parameter for describing the event and values for the parameter.

To accomplish the above objects, according to another exemplary embodiment of the present invention, there is provided a device for managing an event detected by a sensor node in a network in which a plurality of sensornetworks are connected to one another through the Internet, the device being installed in the sensor nodes constituting each of the sensor networks, the device including: an event sensing unit for detecting an event occurring in a location where the sensor node is installed; a policy decision unit for searching whether or not the detected event and a policy for the detected event exist in the sensor node, and deciding the policy for the detected event depending on a result of the search an event query unit for generating, if the policy for the detected event does not exist in the sensor node as the search result, a query message for querying the policy for the detected event, transmitting the generated query message to peripheral sensor nodes or peripheral sensor networks, and receiving a response message including information on the policy for the detected event from the peripheral sensor nodes or the peripheral sensor networks and responding to the query message and a policy generating unit for generating a new policy for the detected event based on the policy information for the detected event included in the response message.

To accomplish the above objects, according to another exemplary embodiment of the present invention, there is provided a device for managing an event detected by a sensor node in a network in which a plurality of sensornetworks are connected to one another through the Internet, the device being installed in the sensor nodes constituting each of the sensor networks, the device including: a policy decision unit for searching whether or not a policy for an event detected in a location where the sensor node is installed exist in the sensor node, and deciding the policy for the detected event depending on a result of the search; a predictable event management unit for managing, if the policy for the detected event exists in the sensor node, the detected event depending on the existing a policy; and a new event management unit for receiving, if the policy for the detected event does not exist in the sensor node, the policy for the detected event from the peripheral sensor nodes or the peripheral sensor networks, and managing the detected event based on the received policy.

### Advantageous Effects

The method and device for managing events detected by sensor nodes according to the present invention has a variety of following advantageous effects over the conventional method of managing events detected by sensor nodes using a policy-based protocol.

First, in the case where unpredictable events are detected, policies for the detected unpredictable events received automatically from peripheral sensor nodes or peripheral sensor networks, so that both predictable and unpredictable events can be managed.

Second, each time unpredictable events are detected, new policies for the detected unpredictable events are automatically generated, so that a manager does not need to update the policies for the unpredictable events every time.

Third, since both predictable and unpredictable events can be managed, the event management method of the present invention can be widely used in a variety of application fields requiring stability and accuracy.

### BRIEF DESCRIPTION OF DRAWINGS

FIG. 1 is a diagram illustrating a topology and a routing method of a conventional sensor network.

FIG. 2 is a block diagram illustrating the configuration of a policy-based management system used in a conventional sensor network.

FIG. 3 is a schematic diagram illustrating an event management system according to an embodiment of the present invention.

FIG. 4 is a functional block diagram illustrating a basic concept of a device for managing events detected by sensor nodes according to an embodiment of the present invention.

FIG. 5 is a functional block diagram illustrating a more concrete configuration of a device for managing events detected by sensor nodes according to an embodiment of the present invention.

FIG. 6 is a flowchart illustrating a process for managing events detected by sensor nodes according to an embodiment of the present invention.

FIG. 7 is a flowchart illustrating the operation for deciding policies for unpredictable events in a policy agent according to an embodiment of the present invention.

FIG. 8 is a flowchart illustrating the operation for generating a response message from a sensor node which has received a query message or a sensor node which belongs to a peripheral sensor network according to an embodiment of the present invention.

FIG. 9 illustrates one example of a query message and a response message according to the present invention.

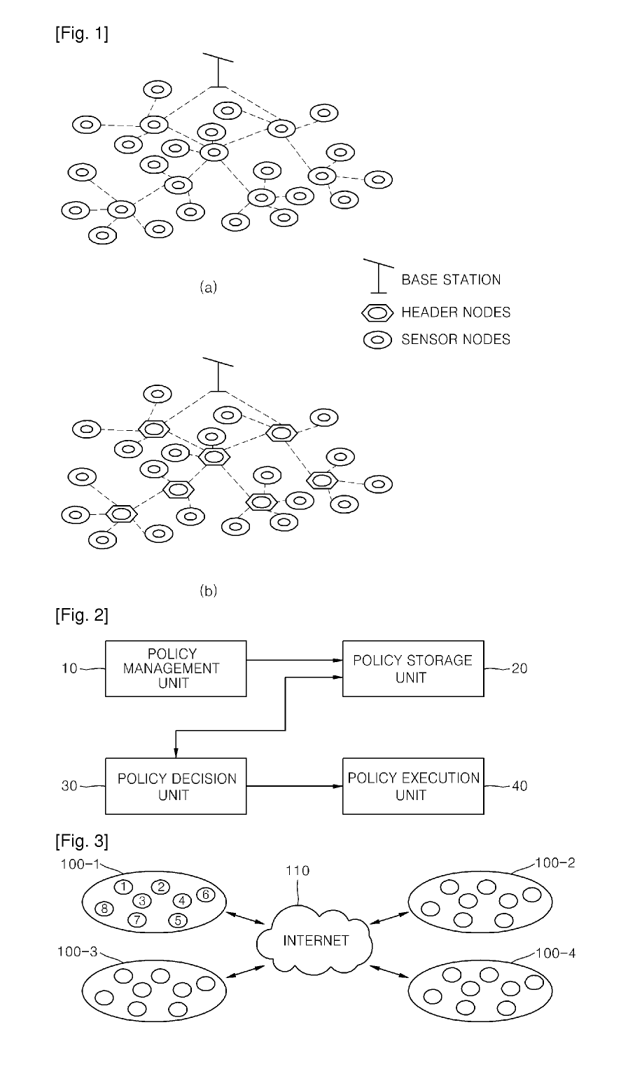

### BEST MODE FOR CARRYING OUT THE INVENTION

Now, a method and device for managing events detected by sensor nodes according to the present invention will be described hereinafter in more detail with reference to the accompanying drawings.

FIG. 3 is a schematic diagram illustrating an event management system according to an embodiment of the present invention.

Referring to FIG. 3, a sensor network 100-1 includes a plurality of sensor nodes 1 to 8. Although it is illustrated that the sensor network 100-1 consists of eight sensor nodes for the sake of explanation, the sensor network 100-1 may include more than eight sensor nodes. The plurality of sensor nodes 1 to 8 constituting the sensor network 100-1 is suited for a sensor network with a planar or hierarchical topology. The sensor nodes constituting the sensor network performs communication with peripheral sensor nodes according to various wired/wireless communication standards. The sensor network 100-1 is connected to the Internet 110 so as to transmit and receive data through the Internet 110.

In the meantime, similar to the sensor network 100-1, a plurality of sensor networks 100-2, 100-3 and 100-4 each including a plurality of sensor nodes also connect to the Internet 110. The sensor networks 100-1, 100-2, 100-3 and 100-4 can transmit and receive data to and from peripheral sensor networks through the Internet 110. The sensor nodes constituting the sensor networks 100-1, 100-2, 100-3 and 100-4 can also transmit and receive data to and from sensor nodes of the peripheral sensor networks through the Internet 110.

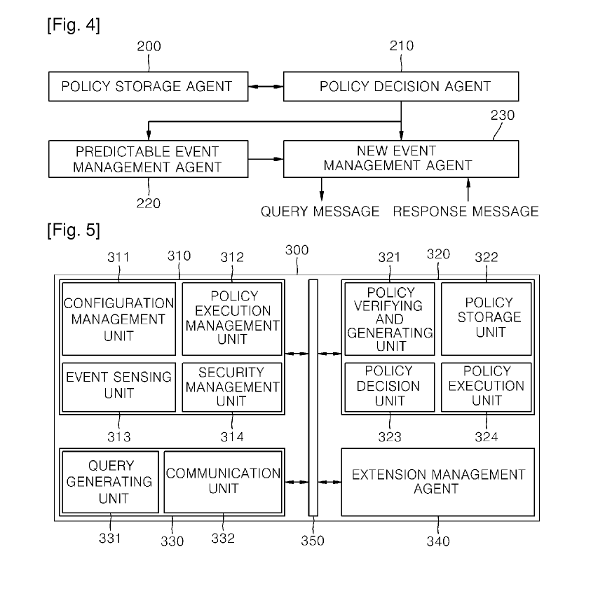

FIG. 4 is a functional block diagram illustrating a basic concept of a device for managing events detected by sensor nodes according to an embodiment of the present invention.

The sensor node event management device which will be described hereinafter is preferably mounted independently at each sensor node.

Referring to FIG. 4, more specifically, policies for events detected by the sensor nodes, which are registered by a manager, are stored in a policy storage agent 200. When a sensing unit of the sensor node detects an event, a policy decision agent 210 requests the policy storage agent 200 to search whether or not a policy for the detected event is stored in the policy storage agent 200.

If the policy storage agent 200 searches that the policy for the detected event is stored therein, the policy decision agent 210 decides the searched policy as a policy for the detected event and transmits the decided policy to a predictable event management agent 230. The predictable event management agent 230 manages the detected event depending on the decided policy. In the meantime, if the policy storage agent 200 searches that the policy for the detected event is not stored therein, a new event management agent 230 generates a query message for querying the policy for the detected event and transmits the generated query message to peripheral sensor nodes or peripheral sensor networks. If the new event management agent 230 receives a response message to the query message from the peripheral sensor nodes or the peripheral sensor networks possessing the policy for the detected event, it generates a new policy for the detected event based on the received response message so as to manage the detected event. The term “agent” as used herein refers to a device which performs an integrated or unit function.

Thus, the sensor node event management device according to the present invention previously stores policies for predictable events therein, and receives a policy for a new unpredictable event from the peripheral sensor nodes or the peripheral sensor networks so as to intelligently manage new events.

FIG. 5 is a functional block diagram illustrating a more concrete configuration of a device for managing events detected by sensor nodes according to an embodiment of the present invention.

Referring to FIG. 5, the sensor node event management device according to one embodiment of the present invention includes a management agent 310 for detecting events occurring through the sensing nodes and performing the overall management operation of the detected events, a policy agent 320 for verifying or generating policies for the detected events, a query agent 330 for making a query for policies for the detected events to peripheral sensor nodes or peripheral sensor networks connecting to the Internet and receiving the policies for the detected events from the peripheral sensor nodes or the peripheral sensor networks, an extension management agent 340 for controlling extension/removal/modification of the agents required for the sensor node event management device, and a communication line 350 for allowing the four agents 310, 320, 330 and 340 to communicate with one another therethrough. The management agent 310 will be described in more detail hereinafter.

A configuration management unit 311 deploys the sensor nodes, creates a topology of the sensor nodes, or specifies the configuration, operation and function of the sensor network according to applications to which the sensor network is applied. Preferably, the deployment of the sensor nodes or the creation of the topology of the sensor nodes is carried out regardless of applications to which the sensor network is applied. A requirement specification inputted through the configuration management unit 311 according to applications to which the sensor network is applied is generated as a policy. A policy execution management unit 312 performs a function depending on a decided policy for a detected event and monitors the performed function. Meanwhile, an event sensing unit 313 detects an event occurring in a location where a sensor node is installed. In the case where the event detected by the event sensing unit 313 is network attack or abnormality, a security management unit 314 serves to protect the sensor network from the network attack or controls the abnormality occurring in the sensor network.

The policy agent 320 will be described in more detail hereinafter.

A policy verifying and generating unit 321 verifies a policy specification generated from information on a policy for a detected event, which is received from peripheral sensor nodes or peripheral sensor networks, and generates a new policy if the policy is an executable policy as a result of the verification. A policy storage unit 322 stores the generated new policy therein, and searches whether or not the policy for the event detected by the event sensing unit 313 is previously registered and stored therein. In the meantime, a policy decision unit 323 decides the registered and stored policy as a policy for a detected event, or generates information on the policy for the detected event from the peripheral sensor nodes or the peripheral sensor networks and decides a generated new policy as a policy for the detected event depending on a result of the search. A policy execution unit 324 generates a policy function or code using a parameter of the policy decided by the policy decision unit 323 so as to allow the policy execution management unit 312 to execute the policy.

The query agent 330 will be described in more detail hereinafter.

In the case where an unpredictable event is detected, a query generating unit 331 generates a query message for querying a policy for the detected unpredictable event, and a communication unit 332 transmits the generated query message to the peripheral sensor nodes or the peripheral sensor networks connecting to the Internet. In the meantime, if the communication unit 332 receives a response message including information on the policy for the detected event and responding to the query message from the peripheral sensor nodes or the peripheral sensor networks, it transfers the received response message to the query generating unit 331. The query generating unit 331 in turn transfers the response message to the policy verifying and generating unit 321. Then, the policy verifying and generating unit 321 extracts the information on the policy for the detected event from the response message so as to draws up a policy specification, and verifies whether or not the drawn policy specification is an executable policy in application areas to which the sensor network is applied so as to generate a new policy for the detected event.

The management agent 310, the policy agent 320), the query agent 330 and the extension management agent 340 according to the present invention transmit and receive data to and from one another through the communication line 350. The communication line 350 may employ various wired/wireless communication standards depending on application areas to which the present invention is applied.

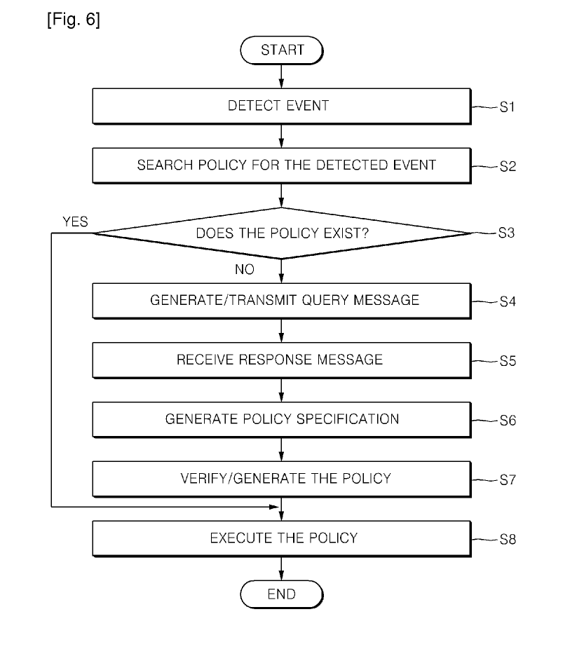

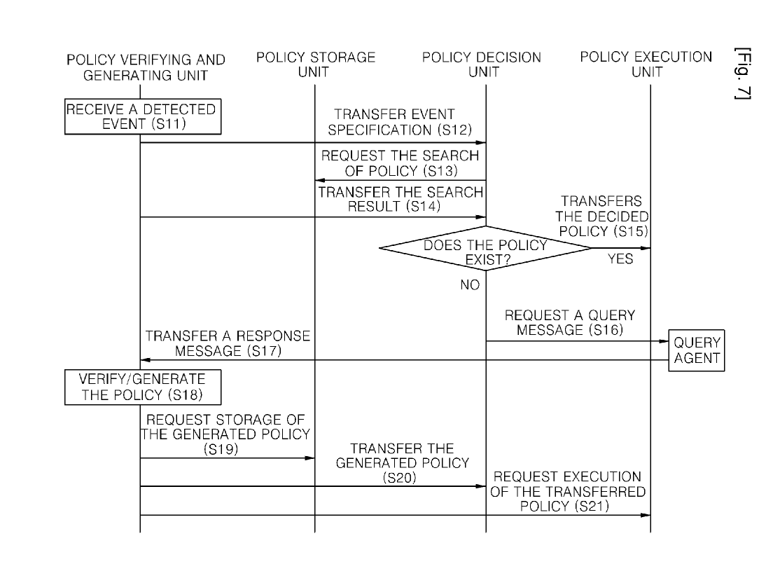

FIG. 6 is a flowchart illustrating a process for managing events detected by sensor nodes according to an embodiment of the present invention.

Referring to FIGS. 5 and 6, the event sensing unit 313 detects an event according to a change in the surrounding environment in a location where a sensor node is installed (S1). When the event sensing unit 313 transfers a specification for the detected event to the policy storage unit 322, the policy storage unit 322 searches whether or not a policy for the detected event is previously registered and stored therein based on the specification for the detected event (S2). If the sensor network is used in environment monitoring applications, the specification for the event may be a temperature change, a value of the temperature change, etc.

The policy decision unit 323 determines whether or not the policy of the detected event exists in the policy storage unit 322 based on a result of the search (S3). Depending on whether the detected event is a predictable event (i.e., whether or not the previously registered/stored policy exits), or the detected event is an unpredictable event (i.e., whether or not the previously registered/stored policy does not exit) based on a result of the determination, if the detected event is a predictable event, the policy decision unit 323 decides the policy for the detected event. On the other hand, if the detected event is an unpredictable event, the policy decision unit 323 transfers a specification for the detected event to the query agent 330 to request the query agent 330 to generate a query message.

Then, the query generating unit 331 generates a query message including query information on a policy for the detected event by referring to the specification for the detected event, and broadcasts the generated query message to the peripheral sensor nodes or the peripheral sensor networks through the communication unit 332 (S4). The query message includes an event type, a parameter required for generating the policy, and values for the parameter.

FIG. 9(a) illustrates one example of a query message according to the present invention.

Herein, a query ID number is an ID number for identifying the query message.

Subsequently, the communication unit 332 receives a response message including the policy information from the peripheral sensor nodes or the peripheral sensor networks (S5), and transfers the policy information included in the received response message to the policy verifying and generating unit 321. The policy information includes a parameter and values for the parameter, which are required for generating the policy for the queried event.

FIG. 9(b) illustrates one example of a response message according to the present invention.

Herein, a response ID number is an ID number for identifying the response message, and the response message is assigned with the same ID number as that of the query message.

The policy verifying and generating unit 321 generates a policy specification based on the transferred the policy information (S6). The policy verifying and generating unit 321 verifies whether or not the policy received from the peripheral sensor nodes or the peripheral sensor networks is a policy executable in applications to which the sensor network is applied based on the generated policy specification. If it is determined that the received policy is an executable policy, the policy verifying and generating unit 321 generates a new policy for the detected event (S7). The new policy for the detected event is registered/stored in the policy storage unit 322. The policy decision unit 323 decides the generated policy as a policy for the detected event, and the policy execution unit 324 executes a detailed management function so as to perform the management of the detected event according to the decided policy.

For the purpose of verification of the policy specification, the policy verifying and generating unit 321 compares information inputted through the configuration management unit 311, i.e., the configuration, function and operation of the sensor network with the policy specification. For example, in the case where the sensor network is used as an unmanned needle detector installed on a ground susceptible to water erosion, when an event occurs in which temperature rises sharply due to fires and the policy verifying and generating unit 321 receives policy information including a function such as water spray or temperature drop from the peripheral sensor nodes or the peripheral sensor networks and generates a policy specification, the policy verifying and generating unit 321 compares the generated policy specification with information on the configuration, the function (unmanned detection) and the operational state (weak ground) of the sensor network so as to determine whether or not the policy is a policy executable in applications to which the sensor network is applied.

FIG. 7 is a flowchart illustrating the operation for deciding policies for unpredictable events in a policy agent according to an embodiment of the present invention.

Referring to FIGS. 5 and 7, the policy verifying and generating unit 321 receives information on a specification of a detected event from the event sensing unit 313 (S11), and transfers the received specification information of the detected event to the policy decision unit 323. Herein, the specification information of the detected event is information indicating an environmental change detected by the event sensing unit 313. The policy decision unit 323 transfers the specification information of the detected event to the policy storage unit 322 and requests the policy storage unit 322 to search whether or not a policy for the detected event exists in the policy storage unit 322 (S13). The policy storage unit 322 transfers a result of the search for the event to the policy decision unit 323 (S14), and the policy decision unit 323 determines whether or not the policy for the detected event exists therein based on the search result. If it is determined that the policy for the detected event exists in the policy storage unit 322, the policy decision unit 323 decides the policy for the detected event and transfers the decided policy to the policy execution unit 324 (S15). On the other hand, if it is determined that the policy for the detected event does on exist in the policy storage unit 322, the policy decision unit 323 transfers the specification information of the detected event to the query agent 330 to request the query agent 330 to generate a query message (S16).

The query agent 330 generates a query message including query information to transmit the generated query message to the peripheral sensor nodes or the peripheral sensor networks, and receives a response message responding to the query message from the peripheral sensor nodes or peripheral sensor networks. The policy verifying and generating unit 321 receives the response message from the query agent 330 (S17), and generates a policy specification based on the policy information included in the received response message. Then, the policy verifying and generating unit 321 verifies the generated policy specification and generates a new policy for the detected event. The policy verifying and generating unit 321 stores the generated new policy in the policy storage unit 322 (S19), and transfers the generated new policy to the policy decision unit 323 (S20). The policy decision unit 323 decides the transferred policy as a policy for the detected event, and re-transfers the decided policy to the policy execution unit 324 to request the policy execution unit 324 to execute the policy (S21).

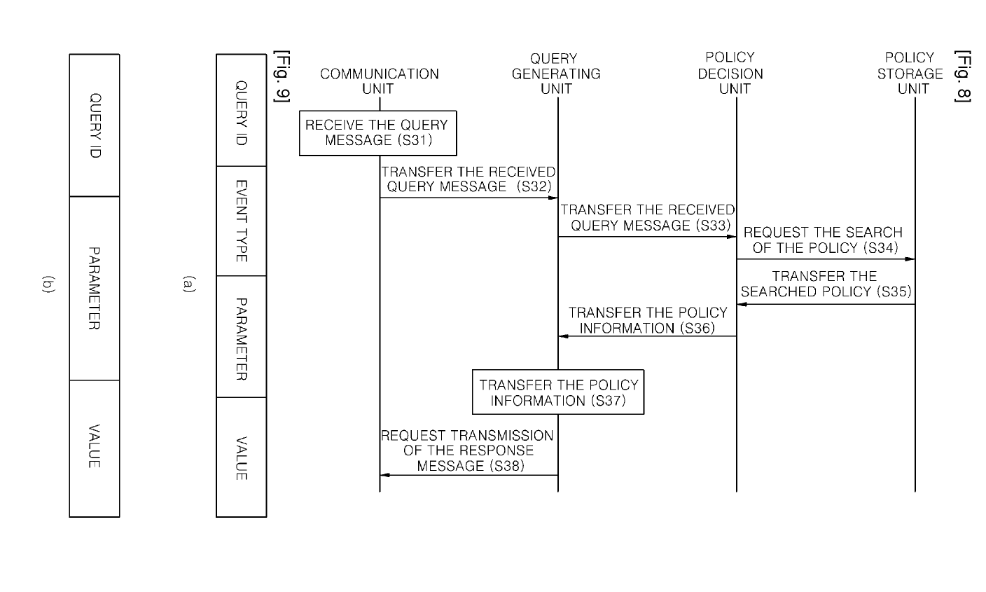

FIG. 8 is a flowchart illustrating the operation for generating a response message from a sensor node which has received a query message or a sensor node which belongs to a peripheral sensor network according to an embodiment of the present invention.

Herein, the sensor node belonging to the peripheral sensor nodes or the peripheral sensor networks has the same configuration as that of the sensor node shown in FIG. 5.

Referring to FIGS. 5 and 8, in the case where the communication unit 332 receives the query message (S31), it transfers the received the query message to the query generating unit 331 (S32). Then, the query generating unit 331 transfers the received query message to the policy decision unit 323) (S33). Thereafter, the policy decision unit 323 extracts query information from the query message and transfers the extracted query information to the policy storage unit 322 to request the policy storage unit 322 to search the policy (S34). Then, the policy storage unit 322 searches whether or not a policy matched with the query information exists therein based on the received query information. If it is searched that the policy matched with the query information exists in the policy storage unit 322, the policy storage unit 322 transfers the specification information of the searched policy to the policy decision unit 323 (S35). Then, the policy decision unit 323 transfers the specification information of the searched policy to the query generating unit 331 (S36), and the query generating unit 331 generates a response message based on the specification information of the searched policy (S37). The query generating unit 331 transfers the generated the response message to the communication unit 332 to request the communication unit 332 to transmit the response message to the sensor node which has transmitted the query message (S38).

In the meantime, the above-mentioned embodiments of the present invention can be implemented in a program which can be executed in a computer, and can be implemented in a general purpose digital computer executing the program using a recoding medium readable by a computer.

The recording medium readable by the computer includes a magnetic storage medium such as, for example, ROMs, floppy disks, hard disks and the like, an optical reading medium such as, for example, CD-ROMs, DVDs and the like, and a carrier wave storage medium such as, for example, transmission over the Internet.

Although the preferred embodiments of the present invention have been described in connection with the exemplary embodiments illustrated in the drawings, they are merely illustrative embodiments. A plurality of constituent elements included in the management agent 310, the policy agent 320 and the query agent 330 may be configured by other combinations. For example, the plurality of constituent elements may be configured in such a fashion as to divide an agent for deciding and managing a policy for a predictable event, i.e., a predictable event management agent, and an agent for deciding and managing a policy for a new unpredictable event, i.e., a new event management agent.

It will be appreciated that and various equivalent modifications and variations of the embodiments can be made by a person having an ordinary skill in the art without departing from the spirit and scope of the present invention. Therefore, the true technical scope of the present invention should be defined by the technical spirit of the appended claims.

1. A method for managing an event detected by a sensor node in a sensor network consisting of sensor nodes, the method comprising the steps of:
(a) detecting an event occurring in a location where the sensor node is installed;
(b) searching whether or not the detected event is registered in the sensor node and a management policy for the detected event exists in the sensor node;
(c) transmitting, if the policy for the detected event does not exist in the sensor node as a search result, a query message including query information on the policy for the detected event to peripheral sensor nodes or peripheral sensor networks
(d) generating a new policy for the detected event based on a response message including information on the policy for the detected event, the response message being received from the peripheral sensor nodes or the peripheral sensor networks and responding to the query message and
(e) managing the detected event depending on the generated new policy.

2. The method according to claim 1, wherein the query message is broadcasted to the peripheral sensor nodes or the peripheral sensor networks of the sensing node which has detected the event, and includes the query information such as a query identifier, an event type, a parameter for describing the event and values for the parameter.

3. The method according to claim 2, wherein the query information includes an identifier for identifying the query, an event type, a parameter for describing the event, and a value for the parameter.

4. The method according to claim 2, wherein the step (d) further comprises the steps of:
extracting the policy information from the response message received from the peripheral sensor nodes or the peripheral sensor networks and responding to the query message;
generating a policy specification executable in the sensor node based on the extracted policy information;
verifying whether or not the generated policy specification is a policy executable in the sensor node which has detected the event;
generating a new policy for the detected event depending on the generated policy specification based on a result of the verification; and
storing the generated new policy in the sensor node.

5. The method according to claim 4, wherein the information of the policy for the detected event includes an identifier for identifying the query, a parameter for describing the event, and a value for the parameter.

6. A device for managing an event detected by a sensor node in a network in which a plurality of sensornetworks are connected to one another through the Internet, the device being installed in the sensor nodes constituting each of the sensor networks, the device comprising:
an event sensing unit for detecting an event occurring in a location where the sensor node is installed;
a policy decision unit for searching whether or not the detected event and a policy for the detected event exist in the sensor node, and deciding the policy for the detected event depending on a result of the search;
an event query unit for generating, if the policy for the detected event does not exist in the sensor node as the search result, a query message for querying the policy for the detected event, transmitting the generated query message to peripheral sensor nodes or peripheral sensor networks, and receiving a response message including information on the policy for the detected event from the peripheral sensor nodes or the peripheral sensor networks and responding to the query message; and
a policy generating unit for generating a new policy for the detected event based on the policy information for the detected event included in the response message.

7. The device according to claim 6, further comprising a storage unit for storing an event detectable by the sensor node and a policy for the detectable event, wherein the new policy for the detected event generated from the policy generating unit is stored in the storage unit.

8. The device according to claim 7, wherein the event query unit broadcasts the generated query message to the peripheral sensor nodes or the peripheral sensor networks.

9. The device according to claim 8, wherein the policy generating unit comprises:
an extractor for extracting the policy information for the detected event from the received response message;
a policy specification unit for drawing up an executable policy specification based on the extracted policy information;
a verifying unit for verify whether or not the drawn policy specification is a policy specification executable in the sensor node; and
a generating unit for generating the new policy for the detected event depending on a result of the verification.

10. A device for managing an event detected by a sensor node in a network in which a plurality of sensornetworks are connected to one another through the Internet, the device being installed in the sensor nodes constituting each of the sensor networks, the device comprising:
a policy decision unit for searching whether or not a policy for an event detected in a location where the sensor node is installed exist in the sensor node, and deciding the policy for the detected event depending on a result of the search;
a predictable event management unit for managing, if the policy for the detected event exists in the sensor node, the detected event depending on the existing a policy; and
a new event management unit for receiving, if the policy for the detected event does not exist in the sensor node, the policy for the detected event from the peripheral sensor nodes or the peripheral sensor networks, and managing the detected event based on the received policy.
